(19) United States
(12) Patent Application Publication
(10) Pub. No.: US 2008/0016529 A1
(43) Pub. Date: Jan. 17, 2008

(54) Information processing system, information providing apparatus, information providing method, reproducing apparatus, information processing method, and program

(75) Inventor: Mitsuhiro Kitagawa, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 11/804,889

(22) Filed: May 21, 2007

(30) Foreign Application Priority Data
May 23, 2006 (JP) P2006-142336

(51) Int. Cl. G06F 3/00

(52) U.S. Cl. 725/39

(57) ABSTRACT

Disclosed herein is an information processing system which may include an information providing apparatus, and a reproducing apparatus. The information providing apparatus may be connected via a network to the reproducing apparatus configured to reproduce contents and to a creating apparatus configured to create related information about the contents, including an acquisition section, a creation section, and a transmission section. The reproducing apparatus may be connected to the information providing apparatus via the network, including an acquisition section, and an output section.

### CROSS-REFERENCE TO RELATED APPLICATIONS

This application claims priority from Japanese Patent Application No. JP 2006-142336 filed in the Japanese Patent Office on May 23, 2006, the entire content of which is incorporated herein by reference.

### BACKGROUND OF THE INVENTION

1. Field of the Invention

The present invention relates to an information processing system, an information providing apparatus, an information providing method, a reproducing apparatus, an information processing method, and a program. More particularly, the invention relates to an information processing system, an information providing apparatus, an information providing method, a reproducing apparatus, an information processing method, and a program whereby content-related information such as information created by general users for output during reproduction of a given content is easily made available to content viewers.

2. Description of the Related Art

In digital broadcasting today, information related to TV programs is generally provided to TV program viewers by means of data broadcasting.

Japanese Patent Laid-open No. 2005-26367 (called Patent Document 1 hereunder) discloses a system that provides different users with different kinds of content-related information. The disclosed system involves transmitting not the content-related information itself but URLs (uniform resource locators) permitting access to relevant websites for users at their receiving terminals to choose from. That is, the system offers content-related information by means of communication based on the Internet in particular.

In another development, Japanese Patent Laid-open No. 2005-217816 (Patent Document 2) discloses a system that allows subtitle data of movies to be downloaded over networks.

### SUMMARY OF THE INVENTION

The current practice of providing information through data broadcasting has two major disadvantages. Firstly, all viewers are offered only the same information. Secondly, information providers are limited to among content providers such as broadcasting stations.

The system disclosed by Patent Document 1 above also has difficulty in solving the second problem above experienced in the current data broadcasting setup. That is because the websites offered as sources of content-related information are mostly provided by content providers.

Systems like the one disclosed by Patent Document 1 have been proposed to provide users in possession of Web browser-capable receiving terminals with not only information offered through data broadcasting but also information given over the Internet. One disadvantage of such systems is that they require users to search for content-related information on their own initiative. These systems have yet to present users with relevant information in an appreciably easy manner.

For example, the offering of information is not easy enough when users need to enter keywords to search for the relevant information. As another example, viewers wishing to watch a TV drama may search for and find related information which turns out to reveal the ending of the drama prematurely. This is not an appropriate way to present information to users.

In another context, film subtitles as content-related information often differ greatly from one translator to another depending on their experiences and sensitivity. Such differences in subtitles can significantly affect the impression of a given movie as a whole. From this, a strong need may be presumed to exist for viewers to select their preferred subtitles of a given film from among the offerings of different translators. Following the selection, the data of the subtitles should preferably be downloaded easily by the viewer.

The present invention has been made in view of the above circumstances and provides arrangements allowing content viewers to make easy use of content-related information created by general users.

In carrying out the present invention and according to one embodiment thereof, there is provided an information processing system which may include an information providing apparatus and a reproducing apparatus. The information providing apparatus may be connected via a network to the reproducing apparatus configured to reproduce contents and to a creating apparatus configured to create related information about the contents. The information providing apparatus may include an acquisition section configured to acquire the related information created by the creating apparatus; a creation section configured to create a list of the acquired related information including content identification information associated with the related information; and a transmission section configured to transmit the list to the reproducing apparatus and, as requested by the reproducing apparatus based on information included in the list, further transmit the related information about a given content to the reproducing apparatus. The reproducing apparatus may be connected to the information providing apparatus via the network, which may includes an acquisition section configured to acquire the list from the information providing apparatus and, based on the content identification information included in the list, further acquire from the information providing apparatus the related information about the content selected to be processed; and an output section configured to output relevant information during reproduction of the selected content in accordance with information included in the related information acquired by the acquisition section.

According to another embodiment of the present invention, there is provided an information providing apparatus which may be connected via a network to a reproducing apparatus configured to reproduce contents and to a creating apparatus configured to create related information about the contents. The information providing apparatus may include an acquisition section configured to acquire the related information created by the creating apparatus; a creation section configured to create a list of the acquired related information including content identification information associated with the related information; and a transmission section configured to transmit the list to the reproducing apparatus and, as requested by the reproducing apparatus based on information included in the list, further transmit the related information about a given content to the reproducing apparatus.

According to a further embodiment of the present invention, there is provided an information providing method for use with an information providing apparatus which may be connected via a network to a reproducing apparatus configured to reproduce contents and to a creating apparatus configured to create related information about the contents, as well as a program for causing a computer to execute an information providing process of the same information providing apparatus. The information providing method and the program each may include acquiring the related information created by the creating apparatus; creating a list of the acquired related information including content identification information associated with the related information; and transmitting the list to the reproducing apparatus and, as requested by the reproducing apparatus based on information included in the list, further transmitting the related information about a given content to the reproducing apparatus.

According to an even further embodiment of the present invention, there is provided a reproducing apparatus which may be connected via a network to an information providing apparatus which acquires related information about contents from a creating apparatus configured to create the related information and which for management purposes creates a list of the acquired related information including content identification information associated with the related information. The reproducing apparatus may include an acquisition section configured to acquire the list from the information providing apparatus and, based on the content identification information included in the list, further acquire from the information providing apparatus the related information about the content selected to be processed; and an output section configured to output relevant information during reproduction of the selected content in accordance with information included in the related information acquired by the acquisition section.

Preferably, if information for setting timings to output the relevant information is included in the related information acquired by the acquisition section, then the output section may output the relevant information during reproduction of the selected content in keeping with the output timings thus set.

Preferably, the output section may display a table of the related information acquired by the acquisition section and, based on information included in the related information selected by a user from the table, may output the relevant information.

Preferably, if the list further includes abstracts from the related information, then the output section may display the table of the related information acquired by the acquisition section together with the abstracts corresponding to individual items of the related information.

Preferably, the acquisition section may acquire the list from the information providing apparatus periodically at predetermined intervals whenever acquiring the related information from the creating apparatus, the acquisition section further acquiring the list alternatively when notified of any update in the list of the related information about the contents.

Preferably, the acquisition section may acquire from the information providing apparatus the related information about the content selected to be processed, in accordance with information including a URL indicating where the content-related information included in the list is located.

Preferably, during reproduction of the selected content, the output section may output the information designated by a user of the creating apparatus in accordance with information included in the related information acquired by the acquisition section.

Preferably, if a keyword included in either a title or constituents of the content selected to be processed is found to have a match in any of the contents covered by the list, then the acquisition section may acquire the related information from the information providing apparatus.

Preferably, the reproducing apparatus according to the invention may further include a recording control section configured to control recording of a desired content; wherein the acquisition section may acquire the related information about the desired content to be recorded from the information providing apparatus; and wherein the output section may output to the recording control section the related information about the desired content acquired by the acquisition section in conjunction with the desired content.

According to a still further embodiment of the present invention, there is provided an information processing method for use with a reproducing apparatus which may be connected via a network to an information providing apparatus which acquires related information about contents from a creating apparatus configured to create the related information and which for management purposes creates a list of the acquired related information including content identification information associated with the related information, as well as a program for causing a computer to execute information processing of the same reproducing apparatus. The information processing method and the program each may include acquiring the list from the information providing apparatus and, based on the content identification information included in the list, further acquiring from the information providing apparatus the related information about the content selected to be processed; and outputting relevant information during reproduction of the selected content in accordance with information included in the related information acquired.

In essence, the information providing apparatus of the information processing system according to the invention may work as follows: the related information created by the creating apparatus may first be acquired. A list may then be created of the acquired related information including content identification information associated with the related information. The list may be transmitted to the reproducing apparatus and, as requested by the reproducing apparatus based on information included in the list, the related information about a given content selected as a content to be processed by the reproducing apparatus is further transmitted to the reproducing apparatus.

The reproducing apparatus of the information processing system according to the invention may work as follows: the list may be acquired from the information providing apparatus and, based on the content identification information included in the list, the related information about the content selected to be processed may further be acquired from the information providing apparatus. Relevant information may then be output during reproduction of the selected content in accordance with information included in the related information acquired by the acquisition section.

The information providing apparatus according to the invention may work as follows: related information created by the creating apparatus may first be acquired. A list may be created of the acquired related information including content identification information associated with the related information. The list may be transmitted to the reproducing apparatus and, as requested by the reproducing apparatus based on information included in the list, the related information about a given content is further transmitted to the reproducing apparatus.

The reproducing apparatus according to the invention may work as follows: a list may be acquired from the information providing apparatus and, based on the content identification information included in the list, the related information about the content selected to be processed may be further acquired from the information providing apparatus. Relevant information may be output during reproduction of the selected content in accordance with information included in the related information acquired by the acquisition section.

According to the present invention, as outlined above, the information created by general users may be utilized easily as related information about contents.

### BRIEF DESCRIPTION OF THE DRAWINGS

Further advantages of the present invention will become apparent upon a reading of the following description and appended drawings in which:

FIG. 1 is a schematic view showing a typical configuration of a search/acquisition/reproduction system that searches for, acquires and reproduces content-related information;

FIG. 2 is a block diagram showing a typical functional structure of a digital broadcast receiving terminal;

FIG. 3 is a block diagram showing a typical functional structure of a content-related information providing site managing apparatus;

FIG. 4 is a schematic view showing relations between a content-related information list and content-related information;

FIG. 5 is a schematic view showing a typical data structure of a content-related information list;

FIG. 6 is a schematic view showing a typical data structure of content-related information;

FIG. 7 is a flowchart of steps constituting a list creation process performed by the content-related information providing site managing apparatus;

FIG. 8 is a flowchart of steps constituting a provision process performed by the content-related information providing site managing apparatus;

FIG. 9 is a flowchart of steps constituting a search and acquisition process performed by the digital broadcast receiving terminal;

FIG. 10 is a flowchart of steps constituting a content display process performed by the digital broadcast receiving terminal;

FIG. 11 is a flowchart of steps detailing what takes place in step S43 of FIG. 10;

FIG. 12 is a flowchart of steps detailing what takes place in step S45 of FIG. 10;

FIG. 13 is a flowchart of steps detailing what takes place in step S47 of FIG. 10;

FIG. 14 is a flowchart of steps detailing what takes place in step S49 of FIG. 10;

FIG. 15 is a flowchart of steps detailing what takes place in step S51 of FIG. 10;

FIG. 16 is a block diagram showing another functional structure of the digital broadcast receiving terminal;

FIG. 17 is a block diagram showing a typical functional structure of a recording media reproducing terminal; and

FIG. 18 is a block diagram showing a typical structure of a personal computer.

### DETAILED DESCRIPTION

What is described below as the preferred embodiments of the present invention with reference to the accompanying drawings corresponds to the appended claims as follows: the description of the preferred embodiments basically provides specific examples supporting what is claimed. If any example of the invention described below as a preferred embodiment does not have an exactly corresponding claim, this does not means that the example in question has no relevance to the claims. Conversely, if any example of the invention described hereunder has a specifically corresponding claim, this does not mean that the example in question is limited to that claim or has no relevance to other claims.

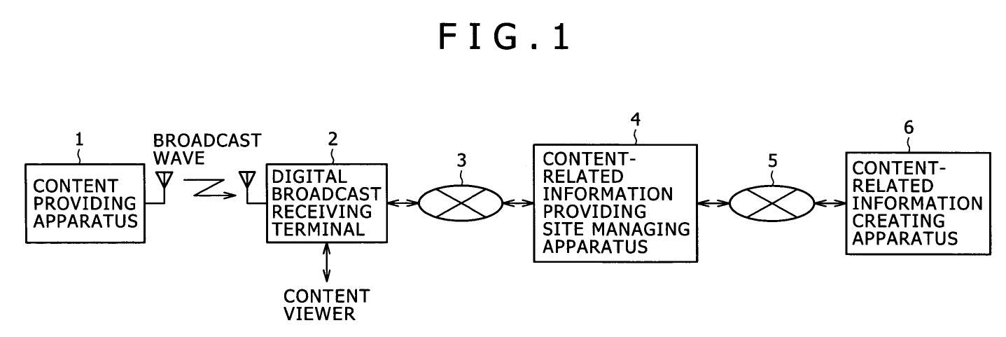

One preferred embodiment of the present invention is an information processing system (e.g., search/acquisition/reproduction system in FIG. 1) primarily including an information providing apparatus (e.g., content-related information providing site managing apparatus 4 in FIG. 1) and a reproducing apparatus (e.g., digital broadcast receiving terminal 2 in FIG. 1), the two apparatuses being a preferred embodiment each as well. In the ensuing description, these two inventive apparatuses will be shown to be embodied illustratively as outlined below.

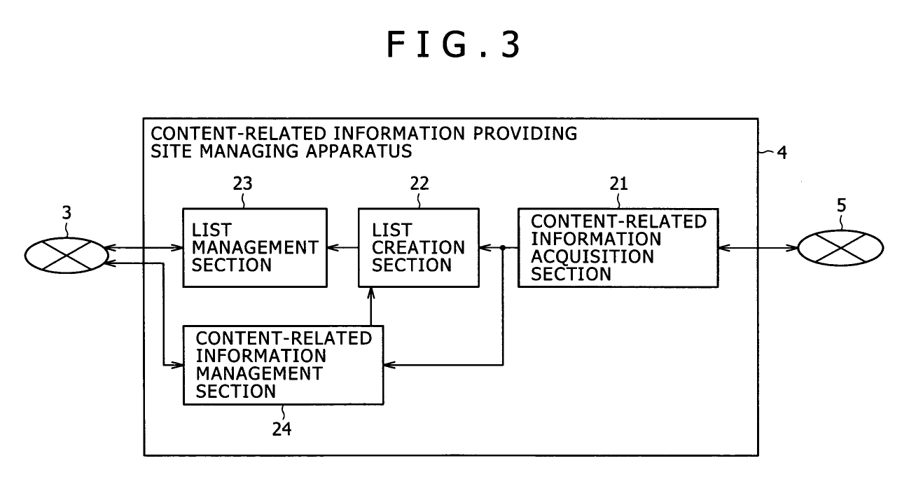

The information providing apparatus (e.g., content-related information providing site managing apparatus 4 in FIG. 1) serving as part of the inventive system above and provided as another preferred embodiment of the present invention is connected via a network to a reproducing apparatus (e.g., digital broadcast receiving terminal 2 in FIG. 1) configured to reproduce contents and to a creating apparatus (e.g., content-related information creating apparatus 6 in FIG. 1) configured to create related information about the contents. The information providing apparatus includes: acquisition means (e.g., content-related information acquisition section 21 in FIG. 3) configured to acquire the related information created by the creating apparatus; creation means (e.g., list creation section 22 in FIG. 3) configured to create a list of the related information acquired by the acquisition means including content identification information associated with the related information; and a transmission section (e.g., list management section 23 in FIG. 3) configured to transmit the list to the reproducing apparatus and, as requested by the reproducing apparatus based on information included in the list, further transmit the related information about a given content selected as a content to be processed by the reproducing apparatus to the reproducing apparatus.

A further embodiment of the present invention is an information providing method as well as a program each including the steps of: acquiring related information created by a creating apparatus; creating a list of the acquired related information including content identification information associated with the related information; and transmitting (e.g., in step S12 of FIG. 8) the list to a reproducing apparatus and, as requested by the reproducing apparatus based on information included in the list, further transmitting the related information about a given content to the reproducing apparatus.

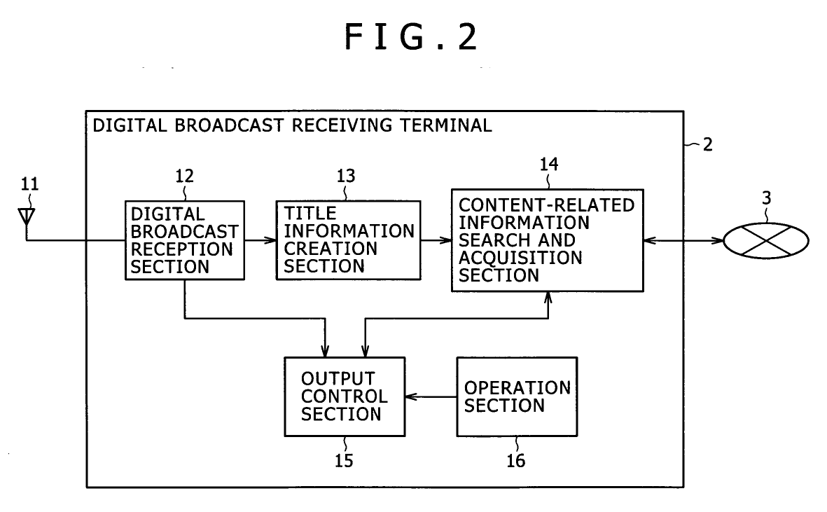

The reproducing apparatus (e.g., digital broadcast receiving terminal 2 in FIG. 1) serving as part of the inventive system above and provided as an even further preferred embodiment of the present invention is connected via a network to an information providing apparatus (e.g., content-related information providing site managing apparatus 4 in FIG. 1) which acquires related information about contents from a creating apparatus configured to create the related information and which for management purposes creates a list of the acquired related information including content identification information associated with the related information. The reproducing apparatus includes: acquisition means (e.g., content-related information search and acquisition section 14 in FIG. 2) configured to acquire the list from the information providing apparatus and, based on the content identification information included in the list, further acquire from the information providing apparatus the related information about the content selected to be processed; and output means (e.g., output control section 15 in FIG. 2) configured to output relevant information designated by a user of the creating apparatus during reproduction of the selected content in accordance with information included in the related information acquired by the acquisition section.

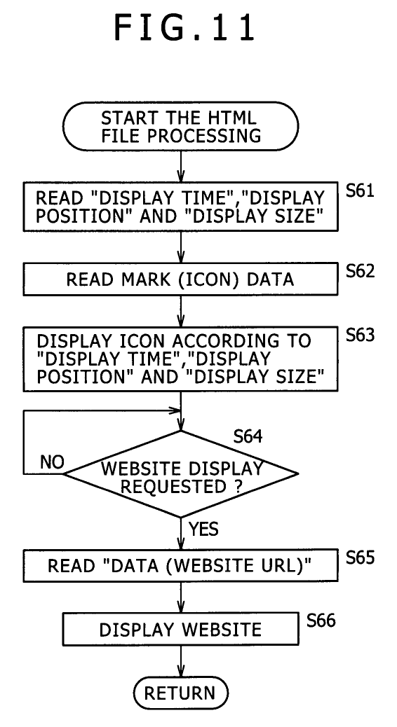

A still further embodiment of the present invention is an information processing method as well as a program each including the steps of: acquiring a list from an information providing apparatus and, based on content identification information included in the list, further acquiring from the information providing apparatus the related information about the content selected to be processed; and outputting (e.g., in step S66 of FIG. 11) relevant information during reproduction of the selected content in accordance with information included in the related information acquired.

The preferred embodiments of the present invention will now be described in reference to the accompanying drawings. FIG. 1 is a schematic view showing a typical configuration of a search/acquisition/reproduction system as one preferred embodiment of the invention which searches for, acquires and reproduces content-related information.

As shown in FIG. 1, the system is essentially made up of a content providing apparatus 1, a digital broadcast receiving terminal 2, a content-related information providing site managing apparatus 4, and a content-related information creating apparatus 6. The digital broadcast receiving terminal 2 and the content-related information providing site managing apparatus 4 are interconnected via a communication line 3. The content-related information providing site managing apparatus 4 and the content-related information creating apparatus 6 are interconnected via a communication line 5.

The content providing apparatus 1 is illustratively set up at a broadcasting station and managed by content providers. In operation, the content providing apparatus 1 offers contents such as TV programs through terrestrial digital broadcasting and/or BS (broadcasting satellite) or CS (communications satellite) digital broadcasting.

The digital broadcast receiving terminal 2 is equipment such as a TV set or a recording device. In operation, the digital broadcast receiving terminal 2 acquires contents provided by content providers over broadcast waves, and presents its user (i.e., content viewer) with the acquired contents.

The digital broadcast receiving terminal 2 is also capable of accessing the content-related information providing site managing apparatus 4 via the communication line 3, and searches for and acquires related information about the content to be processed from the managing apparatus 4. In accordance with information contained in the content-related information thus acquired, the digital broadcast receiving terminal 2 outputs such information as text, moving pictures and/or video during reproduction of the content being processed.

As will be discussed later, the content-related information includes not only information for identifying the information to be output during content reproduction, but also information for setting timings to output the related information.

The content-related information to be used during content reproduction is thus searched for and acquired by the digital broadcast receiving terminal 2 in a suitably timed manner according to a content-related information list managed by the content-related information providing site managing apparatus 4 without the viewer's intervention. The content-related information list includes the titles of the contents covered by all content-related information managed by the content-related information providing site managing apparatus 4, as well as URLs (uniform resource locators) indicating where the content-related information is located.

The content-related information providing site managing apparatus 4 manages content-related information providing sites and provides a content-related information list to the digital broadcast receiving terminal 2 over the communication line 3. In response to requests made by the digital broadcast receiving terminal 2 based on information contained in the content-related information list, the content-related information providing site managing apparatus 4 provides content-related information to the digital broadcast receiving terminal 2.

The content-related information providing site managing apparatus 4 acquires the content-related information uploaded by the content-related information creating apparatus 6 over the communication line 5, and stores the acquired content-related information to suitable locations such as an internal hard disk drive for management purposes. It is the content-related information created by the content-related information creating apparatus 6 that is offered by the content-related information providing site managing apparatus 4 to the digital broadcast receiving terminal 2.

The content-related information creating apparatus 6 is illustratively a personal computer. When suitably operated by its user (i.e., content-related information creator), the content-related information creating apparatus 6 accordingly creates content-related information in a predetermined format. The content-related information creator is generally an ordinary user who has nothing to do with content providers. Such a user may create content-related information about a TV program illustratively by referring to the program-related information offered by the content provider of the program in question prior to a program broadcast.

The content-related information thus created is uploaded to the content-related information providing site managing apparatus 4 by the content-related information creating apparatus 6 in a suitably timed manner.

Only one content-related information creating apparatus 6 is shown in the configuration of FIG. 1. Alternatively, a plurality of apparatuses having similar capabilities may be connected to the communication line 5, and content-related information created by the users of such apparatuses may be uploaded to the content-related information providing site managing apparatus 4. The content-related information providing site managing apparatus 4 may accommodate a plurality of items of related information about each content.

For example, it might happen that a plurality of users have created the subtitles of the same movie and have uploaded content-related information including the subtitle data to the content-related information providing site managing apparatus 4. In that case, before the movie in question is broadcast, a viewer may select a preferred option of subtitles from the results of the search made through the digital broadcast receiving terminal 2. The subtitles thus selected by the viewer may be arranged to replace the default subtitles offered by the content provider and be displayed in synchronism with the moving pictures.

It might also happen that comments on a given TV program were prepared and content-related information including these comments has been uploaded to the content-related information providing site managing apparatus 4. In such a case, the viewer may check the comments during reproduction of the TV program that is commented on.

With the system in FIG. 1, as explained above, ordinary users unrelated to content providers may prepare and offer information that can be presented to viewers as information related to a given TV program during reproduction of that program.

Because the digital broadcast receiving terminal 2 automatically searches for and acquires content-related information including the information to be presented, there is no need for viewers to perform operations to search for content-related information on their own initiative. The operations that can be dispensed with are considerable: if the digital broadcast receiving terminal 2 did not automatically search for and acquire content-related information, the viewer would have to access a relevant website managed by the content-related information providing site managing apparatus 4, get the screen of the accessed website displayed, and input keywords regarding the desired content for search purposes.

Series of steps to be carried out by the digital broadcast receiving terminal 2 and by the content-related information providing site managing apparatus 4 in FIG. 1 will be described below in reference to the accompanying flowcharts.

FIG. 2 is a block diagram showing a typical functional structure of the digital broadcast receiving terminal 2. At least part of the functional blocks shown in FIG. 2 are implemented by the CPU (central processing unit) of the terminal 2 executing appropriate programs.

As shown in FIG. 2, the digital broadcast receiving terminal 2 has a digital broadcast reception section 12, a title information creation section 13, a content-related information search and acquisition section 14, an output control section 15, and an operation section 16 implemented inside. Signals coming from an antenna 11 that receives broadcast waves are supplied to the digital broadcast receiving terminal 2.

In operation, the digital broadcast reception section 12 processes RF signals from the antenna 11 and outputs to the output control section 15 the video and audio data making up the content selected by the viewer. The digital broadcast reception section 12 further outputs PSI (Program Specific Information)/SI (Service Information) including program information about the viewer-selected content to the title information creation section 13.

The title information creation section 13 creates title information from the PSI/SI fed from the digital broadcast reception section 12, and outputs the created title information to the content-related information search and acquisition section 14. The title information includes the title of the viewer-selected content and the keywords regarding the content. For example, a word representing the genre of the TV program in question, the name of a personality appearing in the TV program, and a word selected from an outline of the program may be selected as keywords for the content and included in the title information. The PSI/SI contains these items of information about the TV program of interest.

Using a previously furnished URL, the content-related information search and acquisition section 14 gains access to a suitable content-related information providing site managed by the content-related information providing site managing apparatus 4 and acquires a content-related information list from the accessed site.

The content-related information list may be acquired whenever title information is supplied from the title information creation section 13, or at predetermined intervals. As another alternative, the content-related information list may be acquired when the content-related information providing site managing apparatus 4 notifies that there has been an update in the list in question.

Based on the content-related information list and on the title information fed from the title information creation section 13, the content-related information search and acquisition section 14 searches for the content-related information managed by the content-related information providing site managing apparatus 4 with regard to the viewer-selected content.

Illustratively, the content-related information search and acquisition section 14 may search for the content-related information in the content-related information list as information having the same title as that in the title information coming from the title information creation section 13, or for the content-related information described in the list as information having the same keywords as those in the title information.

The content-related information search and acquisition section 14 acquires the detected content-related information from the content-related information providing site managing apparatus 4 on the basis of information such as a URL in the content-related information list indicating where the content-related information in question is located. The content-related information thus acquired is output to the output control section 15.

The output control section 15 reproduces the data supplied from the digital broadcast reception section 12. In so doing, the output control section 15 enables content video to be displayed on a display device such as LCD (liquid crystal display), not shown, and allows content audio to be output from speakers, not shown.

During content reproduction, the output control section 15 displays the text, moving pictures, and/or website screen designated by the content-related information from the content-related information search and acquisition section 14, in appropriate positions on the display in a suitably timed manner based on the content-related information. If the information designated by the content-related information constitutes audio, then the output control section 15 outputs the audio from the speakers during content reproduction based on the content-related information from the content-related information search and acquisition section 14.

The operation section 16 accepts the operations performed by the viewer using buttons on the enclosure surface of the digital broadcast receiving terminal 2. Alternatively, the operation section 16 accepts the operations made by the viewer using a remote controller. The operation section 16 then outputs information representative of the accepted operations to the output control section 15.

FIG. 3 is a block diagram showing a typical functional structure of the content-related information providing site managing apparatus 4. At least part of the functional blocks shown in FIG. 3 are implemented by the CPU of the content-related information providing site managing apparatus 4 executing appropriate programs.

As shown in FIG. 3, the content-related information providing site managing apparatus 4 has a content-related information acquisition section 21, a list creation section 22, a list management section 23, and a content-related information management section 24 implemented inside.

The content-related information acquisition section 21 acquires the content-related information created by the content-related information creating apparatus 6 and uploaded thereby over the communication line 5. The content-related information thus acquired is output to the list creation section 22 and content-related information management section 24.

The list creation section 22 creates a content-related information list based on the content-related information from the content-related information acquisition section 21 and on URLs indicating where the content-related information from the content-related information management section 24 is located. The content-related information list thus created is forwarded to the list management section 23 which in turns manages the received list.

The list management section 23 manages the content-related information list created by the list creation section 22. The content-related information list being managed by the list management section 23 is sent from there to the digital broadcast receiving terminal over the communication line 3 in a suitably timed manner.

The content-related information management section 24 stores the content-related information from the content-related information acquisition section 21 into a suitable storage location and outputs a URL denoting that storage location to the list creation section 22. In response to a request from the digital broadcast receiving terminal 2 based on the URLs described in the content-related information list, the content-related information management section 24 supplies the requested content-related information to the digital broadcast receiving terminal 2.

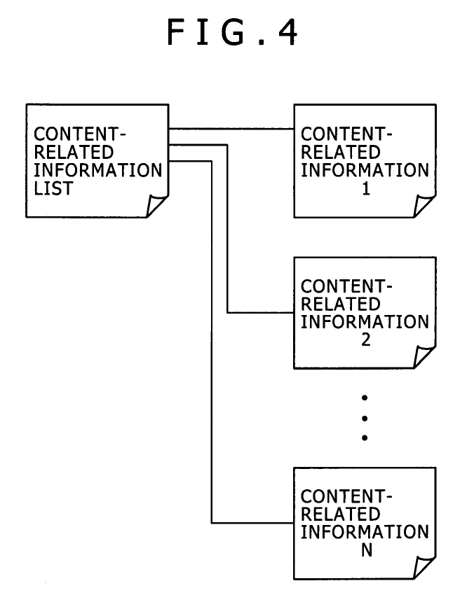

FIG. 4 is a schematic view showing relations between a content-related information list and content-related information. As shown in FIG. 4, the content-related information providing site managing apparatus 4 is in possession of the content-related information list describing information about all content-related information managed by the apparatus 4. A simple reference to the content-related information list allows the digital broadcast receiving terminal 2 to know the storage locations and other data about all content-related information under management of the content-related information providing site managing apparatus 4. In the example of FIG. 4, information about the content-related information 1 through N is described in the content-related information list.

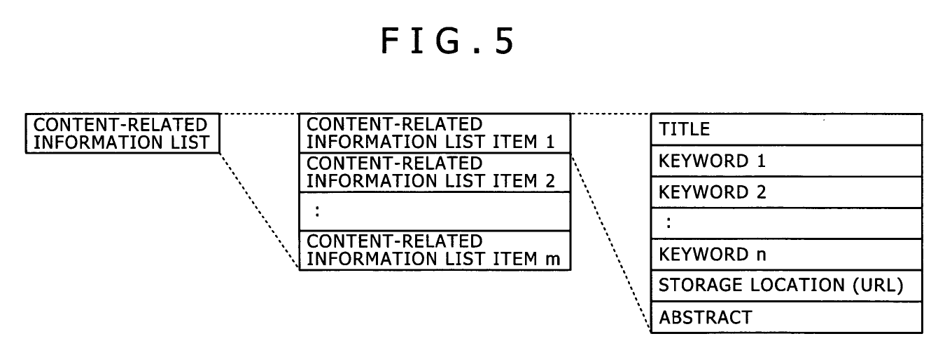

FIG. 5 is a schematic view showing a typical data structure of the content-related information list. As shown in FIG. 5, the content-related information list is made up of a plurality of content-related information list items each constituting related information about an individual content.

A single content-related information list item is typically composed of the title of the content associated with this content-related information, a plurality of keywords including, say, the genre of the content, a URL indicating where the content-related information is located, and an abstract of the content-related information. In the ensuing description, the content-related information list item will be simply referred to as the list item.

The title, keywords, and abstract making up each list item may be prepared either by the list creation section 22 in response to the operations of an administrator of the content-related information providing site managing apparatus 4, or by a content-related information creator. In the latter case, the title, keywords, and abstract are sent from the content-related information creating apparatus 6 to the content-related information providing site managing apparatus 4 when the content-related information in question is uploaded. The title, keywords and abstract thus transmitted are written to the content-related information list by the list creation section 22.

The content-related information list thus structured is prepared by the list creation section 22 and offered by the list management section 23 to the digital broadcast receiving terminal 2. In turn, the digital broadcast receiving terminal 2 searches for content-related information that matches the title or titles and keywords included in the list items constituting the content-related information list. If a list item including the same title as that of the content to be processed is found, or if a list item including the same keywords as those of the target content is detected, then the digital broadcast receiving terminal 2 acquires from the content-related information providing site managing apparatus 4 the content-related information stored in the location designated by the URL described in the detected list item.

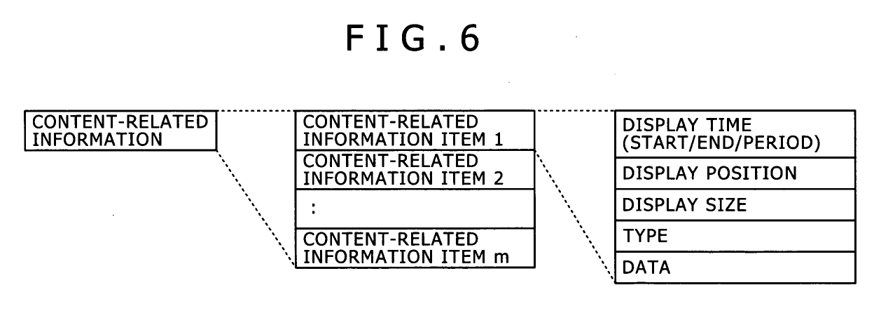

FIG. 6 is a schematic view showing a typical data structure of content-related information. As shown in FIG. 6, the content-related information is illustratively composed of a plurality of content-related information items. Each content-related information item is made up of such entries as a display time, a display position, a display size, the type of the content-related information in question, and data.

If the information to be output during content reproduction is text, moving pictures or a website screen, then the “display time” entry in the item denotes the time to start displaying the information, the time to end the display, and the time period in which to continue the display. If the information for output during content reproduction is audio, then the “display time” entry represents the time to start audio output, the time to end audio output, and the time period in which to continue the output.

Where the information to be output during content reproduction is text, moving pictures or a website screen, the “display position” entry in the item designates that position on the display in which to display the information, the position being defined relative to a reference position on the display.

Where the information to be output during content reproduction is text, moving pictures or a website screen, the “display size” entry in the item specifies the size at which to display the information.

The “type” entry in the item denotes the type of data used for information output during content reproduction. For example, the data type may be a website (HTML (Hyper Text Markup Language) file), text data, a moving picture file, an audio file, or an executable file.

The “data” entry in the item represents diverse information such as data itself for use in outputting information during content reproduction. For example, if the information to be output during content reproduction is text, then the text data to be displayed is described in the “data” entry. If the information for output during content reproduction is a website screen, the URL of the website displaying the screen in question is described in the “data” entry. In addition, if the information for output during content reproduction is a moving picture file, an audio file, or the result of execution of an executable file, then the URL of the website offering the file in question is described in the “data” entry.

The content-related information having the above-described data structure is created by content-related information creators and managed by the content-related information providing site managing apparatus 4 as described.

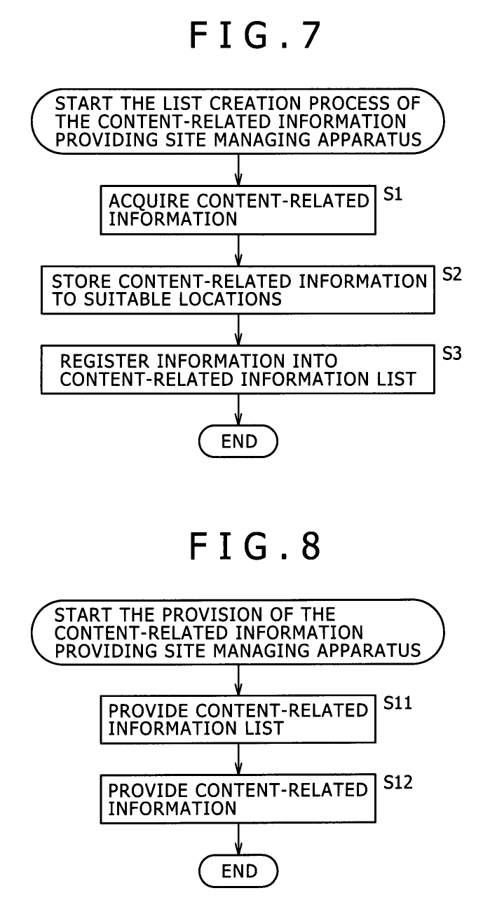

Described below with reference to the accompanying flowcharts are the workings of the digital broadcast receiving terminal 2 and content-related information providing site managing apparatus 4 of which the structures have been discussed above. First to be described in reference to the flowchart of FIG. 7 is how the content-related information providing site managing apparatus 4 works to create a content-related information list.

In step S1, the content-related information acquisition section 21 of the content-related information providing site managing apparatus 4 acquires the content-related information uploaded by the content-related information creating apparatus 6. The content-related information section 21 proceeds to output the acquired content-related information to the list creation section 22 and content-related information management section 24.

Illustratively, suppose that content-related information has been sent from the content-related information creating apparatus 6 together with the title and keywords of the content of interest as well as an abstract of the content-related information. In that case, the content-related information acquisition section 21 also acquires these items of information. The title, keywords and abstract thus acquired are output to the list creation section 22.

In step S2, the content-related information management section 24 stores into a suitable location the content-related information supplied by the content-related information acquisition section 21, and outputs the URL indicating the storage location to the list creation section 22.

In step S3, the list creation section 22 registers the list items into the content-related information list managed by the list management section 23, based on the information supplied from the content-related information acquisition section 21 and on the URL designating the location where the content-related information from the content-related information management section 24 is stored. This brings the processing of the content-related information providing site managing apparatus 4 to an end.

The steps above are typically repeated every time content-related information is uploaded from the content-related information creating apparatus 6. The repeated steps create a content-related information list made up of a plurality of list items as shown in FIG. 5, and the created list is managed by the list management section 23.

Described below with reference to the flowchart of FIG. 8 is how the content-related information providing site managing apparatus 4 works to provide a content-related information list and content-related information. This process is started upon access to the apparatus 4 by the digital broadcast receiving terminal 2. Illustratively, the content-related information providing site managing apparatus 4 may be accessed either at predetermined intervals or when the content to be processed (e.g., a TV program desired to be watched) is selected by the viewer.

In step S11, the list management section 23 provides a content-related information list to the digital broadcast receiving terminal 2 by transmission.

In step S12, the content-related information management section 24 retrieves from an appropriate storage location the content-related information which is about the content designated to be processed by the digital broadcast receiving terminal 2 and which is under management of the section 24. The retrieved information is sent to the digital broadcast receiving terminal 2.

The digital broadcast receiving terminal 2 searches for the content-related information based on the content-related information list provided in step S11. When the content-related information about the content to be processed is found under management of the content-related information management section 24, the digital broadcast receiving terminal 2 requests that the content-related information in question be transmitted.

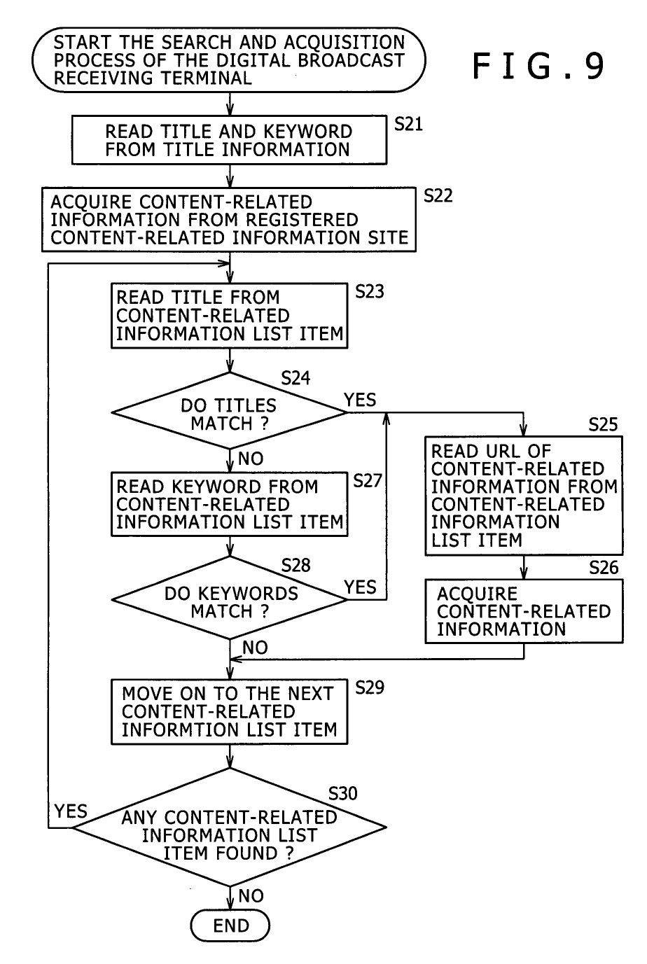

Described below with reference to the flowchart of FIG. 9 is how the digital broadcast receiving terminal 2 searches for and acquires content-related information. The search and acquisition process is carried out illustratively when the content to be processed is selected by the viewer. With the desired content selected by the viewer, the title information creation section 13 of the digital broadcast receiving terminal 2 creates title information including the title and keywords of the content of interest based on the PSI/SI supplied from the digital broadcast reception section 12. The created title information is output to the content-related information search and acquisition section 14.

In step S21, the content-related information search and acquisition section 14 reads the title and keywords from the title information supplied by the title information creation section 13, for use as the information by which to search for the content-related information.

In step S22, the content-related information search and acquisition section 14 acquires the content-related information list by accessing the content-related information providing site managed by the content-related information providing site managing apparatus 4 through the use of a previously registered URL. As explained above, upon access by the digital broadcast receiving terminal 2, the content-related information providing site managing apparatus 4 provides the content-related information list to the terminal 2 (in step S11 of FIG. 8).

If the content-related information is to be acquired from a plurality of devices, then access to these devices is effected using a plurality of registered URLs. The content-related information is then acquired from the accessed devices.

In step S23, the content-related information search and acquisition section 14 selects one of the list items making up the content-related information list, and reads the title from the selected list item of interest.

In step S24, the content-related information search and acquisition section 14 determines whether or not there is a match between the title read from the title information and the title retrieved from the currently selected list item.

If in step S24 a match is found between the title read from the title information and the title retrieved from the selected list item of interest, then step S25 is reached. In step S25, the content-related information search and acquisition section 14 reads the URL included in the selected list item. The retrieved URL denotes the location where the content-related information about the content to be processed is stored in a manner managed by the content-related information providing site managing apparatus 4.

In step S26, the content-related information search and acquisition section 14 accesses the content-related information providing site managing apparatus 4, and acquires the content-related information from the storage location identified by the URL retrieved from the list item of interest.

If in step S24 no match is found between the title read from the title information and the title retrieved from the selected list item, then step S27 is reached. In step S27, the content-related information search and acquisition section 14 reads a keyword or keywords from the currently selected list item.

In step S28, the content-related information search and acquisition section 14 determines whether there is a match between the keyword read from the title information and the keyword retrieved from the currently selected list item.

If in step S28 a match is found between the keyword read from the title information and the keyword retrieved from the selected list item of interest, then the content-related information search and acquisition section 14 goes to step S25 and performs the subsequent steps. That is, the content-related information search and acquisition section 14 acquires from the content-related information providing site managing apparatus 4 the content-related information held in the storage location designated by the URL included in the selected list item.

Where there exist a plurality of keywords retrieved from the title information as well as from the currently selected list item, then it may be arranged to acquire the content-related information only if matches are found with the keywords exceeding a predetermined threshold keyword count.

If in step S28 no match is found between the keyword read from the title information and the keyword retrieved from the currently selected list item, the content-related information search and acquisition section 14 goes to step S29. Step S29 is also reached when the content related information is acquired in step S26.

In step S29, the content-related information search and acquisition section 14 moves on to the list item next to the currently selected one where the list items are arranged in ascending order of their item numbers as shown in FIG. 5.

In step S30, the content-related information search and acquisition section 14 determines whether or not there is any more list item of interest to be selected. If in step S30 a list item to be selected is found, then the content-related information search and acquisition section 14 selects that list item and repeats step S23 and the subsequent steps. If no more list item of interest is found in step S30, then the search and acquisition process is brought to an end.

The steps above when carried out allow the content-related information search and acquisition section 14 to acquire all content-related information about the content to be processed.

In the foregoing description, the search for the content-related information about the content to be processed was shown to be made based on the title and keyword of the content. Alternatively, other information may be used to search for content-related information as long as the information can identify the content of interest. For example, if content IDs are included in the title information as well as in the content-related information list, then the content ID of a desired content may be utilized in searching for the content-related information about the content in question.

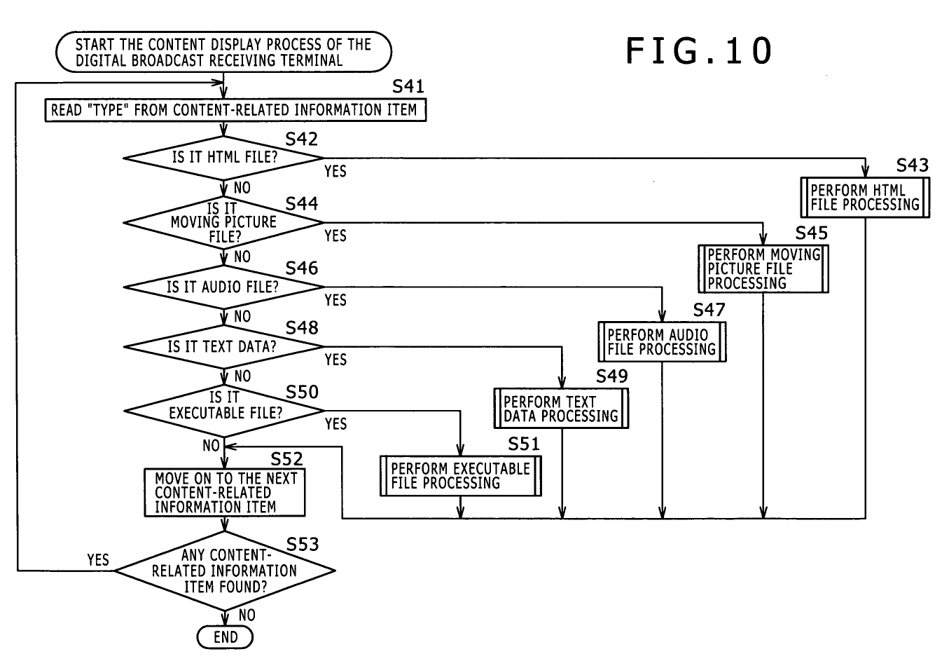

Described below with reference to the flowchart of FIG. 10 is the content display process performed by the digital broadcast receiving terminal 2. This process is started following the process of FIG. 9 in which the content-related information search and acquisition section 14 has acquired all content-related information about the content to be processed. The acquired content-related information is output from the content-related information search and acquisition section 14 to the output control section 15.

In step S41, the output control section 15 selects one of the content-related information items making up the content-related information and reads the “type” entry from the selected item of interest. The retrieved “type” entry identifies the type of the data for use in outputting information based on the selected content-related information item. The data is one of the HTML file type, text data type, moving picture file type, audio file type, and executable file type.

In step S42, the output control section 15 determines whether the data for use in outputting information during content reproduction is the HTML file type. If the data is found to be the HTML file type, then step S43 is reached.

In step S43, the output control section 15 carries out a process applicable when the data for use in outputting information during content reproduction is the HTML file type. Details of the process will be discussed later in reference to the flowchart of FIG. 11. In this process, the display device displays an icon representing the website designed to display screens in a suitably timed manner during content reproduction. By selecting the icon, the viewer can browse the website designated by the creator of the content-related information in question.

In parallel with step S43 being carried out, the video of the content to be processed is displayed on the display device and the audio of the content is output through the speakers under control of the output control section 15. Likewise, when the data for use in outputting information during content reproduction is the text data type, moving picture file type, audio file type, or executable file type (to be described later), the video of the content to be processed is displayed on the display device while the audio of the content is output through the speakers also under control of the output control section 15 in parallel with the processing of the data of the file of interest.

If in step S42 the data to be used for information output during content reproduction is not found to be the HTML file type, then the output control section 15 goes to step S44.

In step S44, the output control section 15 determines whether or not the data to be used for information output during content reproduction is the moving picture file type. If the data is found to be the moving picture file type, then the output control section 15 goes to step S45.

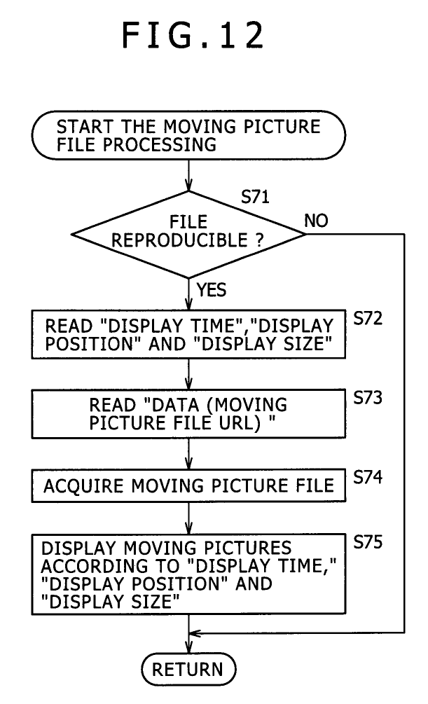

In step S45, the output control section 15 performs a process applicable when the data for use in outputting information during content reproduction is the moving picture file type. Details of the process will be discussed later in reference to the flowchart of FIG. 12. In this process, the moving picture file acquired from the website designated by the creator of the content-related information is reproduced and the video is displayed in a suitably timed manner.

If in step S44 the data to be used for information output during content reproduction is not found to be the moving picture file type, then the output control section 15 goes to step S46.

In step S46, the output control section 15 determines whether or not the data to be used for information output during content reproduction is the audio file type. If the data is found to be the audio file type, then the output control section 15 goes to step S47.

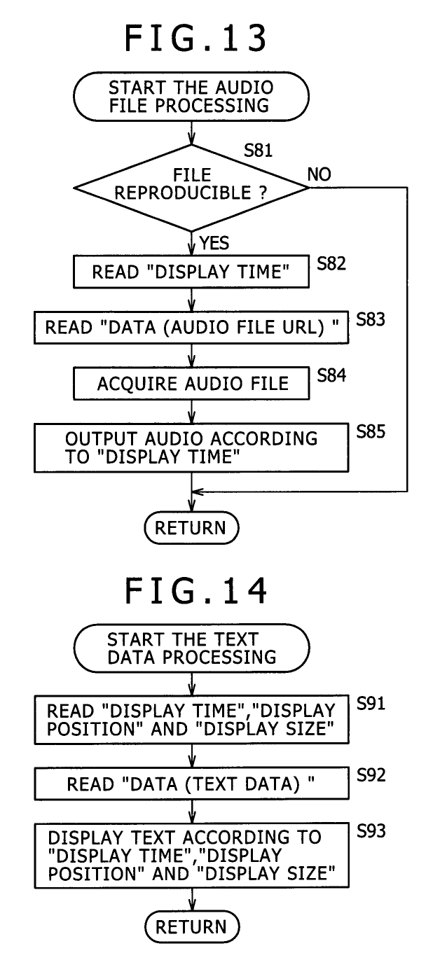

In step S47, the output control section 15 performs a process applicable when the data for use in outputting information during content reproduction is the audio file type. Details of the process will be discussed later in reference to the flowchart of FIG. 13. In this process, the audio file acquired from the website designated by the creator of the content-related information is reproduced and the audio is output in a suitably timed manner.

If in step S46 the data to be used for information output during content reproduction is not found to be the audio file type, then the output control section 15 goes to step S48.

In step S48, the output control section 15 determines whether the data to be used for information output during content reproduction is the text data type. If the data is found to be the text data type, then the output control section 15 goes to step S49.

In step S49, the output control section 15 performs a process applicable when the data for use in outputting information during content reproduction is the text data type. Details of the process will be discussed later in reference to the flowchart of FIG. 14. In this process, text is displayed in a suitably timed manner based on the currently selected content-related information item of interest.

If in step S48 the data to be used for information output during content reproduction is not found to be the text data type, then the output control section 15 goes to step S50.

In step S50, the output control section 15 determines whether the data to be used for information output during content reproduction is the executable file type. If the data is found to be the executable file type, then the output control section 15 goes to step S51.

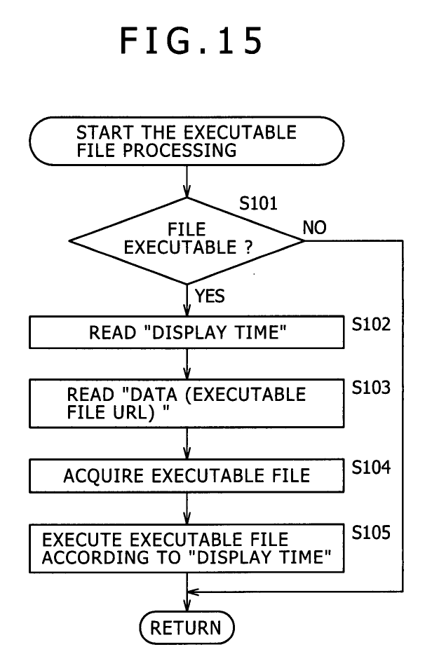

In step S51, the output control section 15 performs a process applicable when the data for use in outputting information during content reproduction is the executable file type. Details of the process will be discussed later in reference to the flowchart of FIG. 15. This process involves executing an executable file downloaded from the website designated by the creator of the content-related information in a suitably timed manner during content reproduction.

If in step S50 the data to be used for information output during content reproduction is not found to be the executable file type, then the output control section 15 goes to step S52. Step S52 is also reached following the processing of step S43, S45, S47, S49, or S51.

In step S55, the output control section 15 moves on to the content-related information item next to the currently selected one in order of their item numbers, and selects the newly accessed item as the item of interest.

In step S53, the output control section 15 determines whether or not there exists any content-related information item yet to be selected. If a content-related information item yet to be selected is found to exist in step S53, then the output control section 15 selects that information item as the item of interest and repeats step S41 and the subsequent steps. If no more content-related information item of interest is found in step S53, then the content display process is brought to an end.

The process above is performed on all content-related information acquired from the content-related information providing site managing apparatus 4.

Alternatively, the process of FIG. 10 may be carried out not only all content-related information acquired from the content-related information providing site managing apparatus 4 but also solely on the content-related information selected by the viewer. In this case, illustratively prior to the process of FIG. 10, the viewer is presented with a table of the content-related information obtained from the content-related information providing site managing apparatus 4 so that the viewer may select the desired content-related information from the table. Selection of the content-related information by the viewer is accepted through the operation section 16. Information denoting the selected content-related information is then output to the output control section 15.

As another alternative, the table of content-related information may include text representative of each content-related information as an explanation of the information based on the abstracts included in the list items.

As a further alternative, the viewer may be allowed to select a mode that suppresses the search for and acquisition of content-related information, the display of the table of content-related information, and the output of any information based on content-related information.

Described below with reference to the flowchart of FIG. 11 are steps detailing what takes place in step S43 of FIG. 10. These are the steps to be carried out when the data for use in outputting information during content reproduction is the HTML file type.

In step S61, the output control section 15 reads the “display time” entry, “display position” entry, and “display size” entry from the selected content-related information item of interest.

In step S62, the output control section 15 reads mark (icon) data from the content-related information item of interest. Where the data to be used for information output during content reproduction is the HTML file type, the “data” entry in the content-related information item describes the data that constitutes an icon.

In step S63, the output control section 15 displays the icon on the display device using the timings, position, and size designated by the creator of the content-related information by means of the “display time” entry, “display position” entry, and “display size” entry.

Illustratively, suppose that the icon in question is designated by the “display time” entry to be displayed for one minute upon elapse of five minutes from the start of a TV program broadcast, that the icon is designated by the “display position” entry to appear in the bottom right corner of the display screen, and that the icon is designated by the “display size” entry to be displayed in a designated size. In that case, based on the data read in step S62, the icon of the designated size is displayed in the bottom right corner of the display screen for one minute upon elapse of five minutes from the start of the TV program broadcast.

If there are provided a plurality of content-related information items for displaying website screens regarding the content to be viewed by the viewer, the same icon may be displayed a plurality of number of times or a plurality of icons may be displayed on the same screen in accordance with the “display time” entry, “display position” entry, and “display size, entry in each of the content-related information items involved.

In step S64, the output control section 15 determines whether or not the icon is selected by the viewer based on the information supplied from the operation section 16 requesting display of a website screen. The output control section 15 waits until the request to display the website screen is detected.

If in step S64 the request to display the website screen is found to be made, then the output control section 15 goes to step S65. In step S65, the output control section 15 reads the URL of the website in question from the content-related information item of interest. If the data for use in outputting information during content reproduction is the HTML file type, then the “data” entry in the content-related information item also describes the URL of the website involved.

In step S66 the output control section 15 illustratively controls the content-related information search and acquisition section 14 to access the website identified by the URL retrieved in step S65 and have the website screen displayed in place of the content video. From step S66, control is returned to step S43 in FIG. 10 and the subsequent steps are carried out.

If the content being watched by the viewer is, say, a live broadcast of a soccer match, the typical website to be accessed for concurrent viewing through selection of a corresponding icon during content reproduction may be a soccer-related website that was created and set up by a content-related information creator enthused over soccer.

Soccer-enthralled content-related information creators can thus present soccer broadcast viewers with the websites they set up. The viewers can search for and acquire information about the broadcast they are watching by inputting desired keywords on their own initiative.

The content-related information creator may designate the “display time” entry in such a manner as to have the icon displayed during the half-time break of the match. This keeps the viewers from inadvertently getting the website displayed during the match. In other words, the information about the soccer broadcast can be presented to viewers in a suitably timed manner. Content-related information creators may verify the TV program listings in advance and, using the content-related information, may specify how long the soccer broadcast should elapse from its start before letting the icon be displayed.

Described below with reference to the flowchart of FIG. 12 are steps detailing what takes place in step S45 of FIG. 10. These are the steps to be carried out when the data for use in outputting information during content reproduction is the moving picture file type.

In step S71, the output control section 15 determines whether the moving picture file in question is reproducible by itself. For example, if such information as the file type and transfer rate of the moving picture file is described in the “data” entry of the content-related information item of interest, then the output control section 15 determines that information whether or not the moving picture file is reproducible.

If in step S71 the moving picture file is not found to be reproducible, then the output control section 15 terminates the process. If the moving picture file is found to be reproducible in step S71, the output control section 15 goes to step S72.

In step S72, the output control section 15 reads the “display time” entry, “display position” entry, and “display size” entry from the content-related information item of interest.

In step S73, from the content-related information item of interest, the output control section 15 reads the URL of the website from which the moving picture file is made available by download or in streaming mode. Where the data to be used for information output during content reproduction is the moving picture file type, the “data” entry in the content-related information item describes the URL of the website that offers the moving picture file in question.

In step S74, the output control section 15 illustratively controls the content-related information search and acquisition section 14 to access the website identified by the URL retrieved in step S73 and acquire the moving picture file from the accessed website.

In step S75, the output control section 15 reproduces the acquired moving picture file and has the moving picture displayed on the display device using the timings, position, and size designated by the creator of the content-related information by means of the “display time” entry, “display position” entry, and “display size” entry. From step S75, control is returned to step S45 in FIG. 10 and the subsequent steps are carried out.

Illustratively, suppose that the moving picture in question is designated by the “display time” entry to be displayed for one minute upon elapse of five minutes from the start of a TV program broadcast, that the moving picture is designated by the “display position” entry to appear in the bottom right corner of the display screen, and that the moving picture is designated by the “display size” entry to be displayed at a designated resolution. In that case, based on the moving picture file acquired in step S74, the moving picture is displayed at the designated resolution in the bottom right corner of the display screen for one minute upon elapse of five minutes from the start of the TV program broadcast.

Described below with reference to the flowchart of FIG. 13 are steps detailing what takes place in step S47 of FIG. 10. These are the steps to be carried out when the data for use in outputting information during content reproduction is the audio file type.

The process in FIG. 13 is basically the same as that in FIG. 12 in which the data for use in outputting information during content reproduction was shown to be the moving picture file type. In step S81, the output control section 15 determines whether the audio file in question is reproducible by itself. For example, if such information as the file type and transfer rate of the audio file is described in the “data” entry of the content-related information item of interest, then the output control section 15 determines that information whether or not the audio file is reproducible.

If in step S81 the audio file is not found to be reproducible, then the output control section 15 terminates the process. If the audio file is found to be reproducible in step S81, the output control section 15 goes to step S82.

In step S82, the output control section 15 reads the “display time” entry from the content-related information item of interest. Where the data is the audio file type, the “display time” entry designates the time to start outputting the audio, the time to end the audio output, and the output period in which the audio in question is output.

In step S83, from the content-related information item of interest, the output control section 15 reads the URL of the website from which the audio file is made available by download or in streaming mode. Where the data to be used for information output during content reproduction is the audio file type, the “data” entry in the content-related information item describes the URL of the website that offers the audio file in question.

In step S84, the output control section 15 illustratively controls the content-related information search and acquisition section 14 to access the website identified by the URL retrieved in step S83 and acquire the audio file from the accessed website.

In step S85, the output control section 15 reproduces the acquired audio file and outputs the audio through the speakers using the timings designated by the “display time” entry. From step S85, control is returned to step S47 in FIG. 10 and the subsequent steps are carried out.

Described below with reference to the flowchart of FIG. 14 are steps detailing what takes place in step S49 of FIG. 10. These are the steps to be carried out when the data for use in outputting information during content reproduction is the text data type.

In step S91, the output control section 15 reads the “display time” entry, “display position” entry, and “display size” entry from the content-related information item of interest.

In step S92, the output control section 15 reads text data from the content-related information item of interest. Where the data to be used for information output during content reproduction is the text data type, the “data” entry in the content-related information item describes the text data for use in text display.

In step S93, based on the text data acquired in step S92, the output control section 15 displays the text on the display device using the timings, position, and size designated by means of the “display time” entry, “display position” entry, and “display size” entry. From step S93, control is returned to step S49 in FIG. 10 and the subsequent steps are carried out.

Illustratively, where the subtitles of a movie are offered as content-related information, each of the content-related information items making up the content-related information includes text to be displayed as subtitles. Sentences of the text are displayed one after another according to the “display time” entry, “display position” entry, and “display size” entry described in the individual content-related information items.

Described below with reference to the flowchart of FIG. 15 are steps detailing what takes place in step S51 of FIG. 10. These are the steps to be carried out when the data for use in outputting information during content reproduction is the executable file type.

In step S101, the output control section 15 determines whether or not the executable file in question is executable by itself. For example, if such information as the file type of the executable file is described in the “data” entry in the content-related information item of interest, then the output control section 15 determines that information whether or not the executable file is indeed executable.

If in step S101 the executable file is not found to be executable, then the output control section 15 terminates the process. If the executable file is found to be actually executable in step S101, the output control section 15 goes to step S102.

In step S102, the output control section 15 reads the “display time” entry from the content-related information item of interest. Where the data is the executable file type, the “display time” entry designates the execution time of the executable file in question, the time to start displaying or outputting the result of execution of the executable file, the time to stop displaying or outputting the result of the execution, and the time period in which to display or output the result of the execution.

In step S103, the output control section 15 reads the URL of the website that offers the executable file from the content-related information item of interest. Where the data to be used for information output during content reproduction is the executable file type, the “data” entry in the content-related information item describes the URL of the website providing the executable file in question.

In step S104, the output control section 15 illustratively controls the content-related information search and acquisition section 14 to access the website identified by the URL retrieved in step S103 and acquire the executable file from the accessed website.

In step S105, the output control section 15 executes the acquired executable file using the timings designated in the “display time” entry, and performs an appropriate process such as display of the result of the execution on the display device in accordance with the execution result. From step S105, control is returned to step S51 in FIG. 10 and the subsequent steps are carried out.

The steps above allow content-related information creators to let viewers make use of the information they have created about a given content. The viewers, for their part, can access diverse content-related information by simply selecting the content desired to be processed.

The above-described inventive system makes it possible for the viewer to enjoy a wide range of options in taking in information about the contents desired to be viewed. The system further permits establishment of a business model in which the providers of applications for creating content-related information can receive payments from users who have acquired such applications, the users being other than content providers.

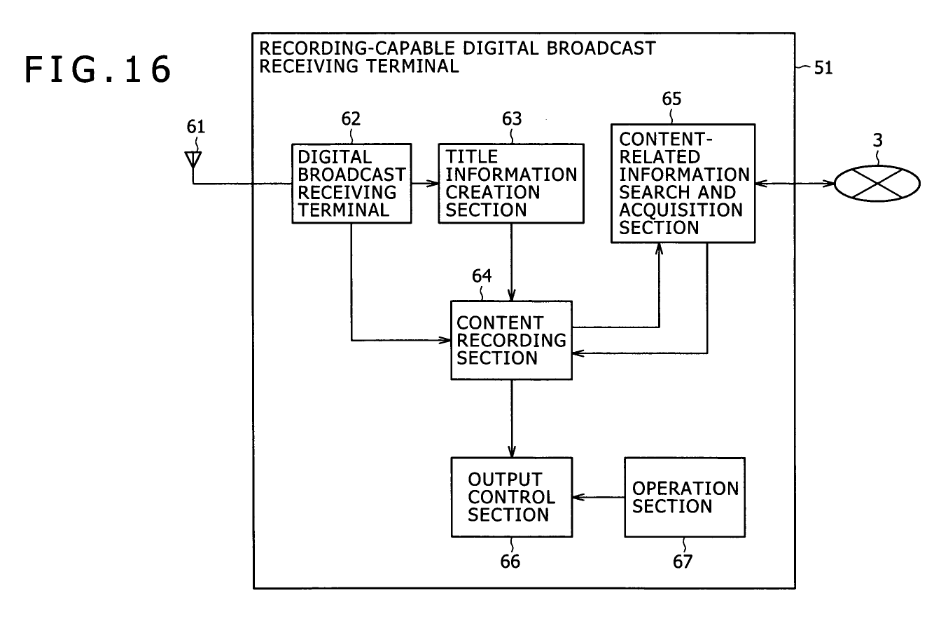

FIG. 16 is a block diagram showing another functional structure of the digital broadcast receiving terminal. The digital broadcast receiving terminal 51 in FIG. 16 is designed to record TV programs. As illustrated, the digital broadcast receiving terminal 51 has a digital broadcast reception section 62, a title information creation section 63, a content recording section 64, a content-related information search and acquisition section 65, an output control section 66, and an operation section 67 implemented inside.

The digital broadcast reception section 62 subjects RF signals coming from an antenna 61 to predetermined process as in the case of the digital broadcast reception section 12 of the digital broadcast receiving terminal 2 in FIG. 2, and outputs the content selected by the viewer illustratively for recording purposes to the content recording section 64. The digital broadcast reception section 62 further outputs PSI/SI including the title and ID of the content of interest to the title information creation section 63.

As with the title information creation section 13 of the digital broadcast receiving terminal 2 in FIG. 2, the title information creation section 63 creates title information from the PSI/SI sent from the digital broadcast reception section 62, and outputs the created title information to the content recording section 64. In turn, the content recording section 64 records the content coming from the digital broadcast reception section 62 to a storage device such as a hard disk drive.

When recording the content from the digital broadcast reception section 62 to the storage device, the content recording section 64 also records the title information including the title and keywords of the content supplied from the title information creation section 63 in conjunction with that content. Before the viewer designates reproduction of the content recorded on the storage device, the content recording device 64 outputs the title information about the content of interest to the content-related information search and acquisition section 65 so that the section 65 may search for and acquire relevant content-related information. When supplied with the acquired content-related information from the content-related information search and acquisition section 65, the content recording section 64 records the supplied content-related information to the hard disk drive or the like in conjunction with the content of interest.

When the viewer designates reproduction of the recorded content, the content recording section 64 reads the designated content as well as the content-related information associated with that content from the storage device for output to the output control section 66.

The content-related information search and acquisition section 65 acquires a content-related information list from the content-related information providing site managing apparatus 4, and searches for the content-related information based on the acquired content-related information list and on the title information sent from the content recording section 64 as discussed above. The content-related information search and acquisition section 65 acquires the detected content-related information from the content-related information providing site managing apparatus 4. The content-related information thus acquired is output to the content recording section 64 whereby the information is recorded in conjunction the content as information to be used upon content reproduction.

When the viewer designates reproduction of the content, the output control section 66 reproduces the content being supplied from the content recording section 64, displaying the video of the content on the display device and outputting the audio through the speakers. On the basis of the content-related information supplied from the content recording section 64 in conjunction with the content of interest, the output control section 66 displays the images or moving picture of an appropriate website and outputs the audio involved through the speakers.

The operation section 67 accepts the operations performed by the viewer, and outputs information denoting what the operations signify to the output control section 66.

As described, it can be arranged to output information based on content-related information not during reproduction of a broadcast content in real time but upon reproduction of a previously recorded content. In the latter case, the content has already been broadcast so that the content-related information offered to users can be devised more elaborately than before.

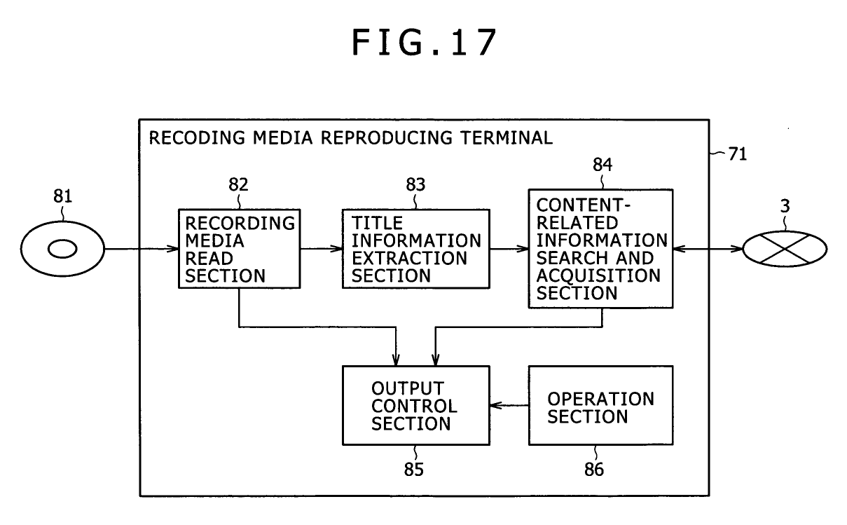

FIG. 17 is a block diagram showing a typical functional structure of a recording media reproducing terminal 71. The recording media reproducing terminal 71 shown in FIG. 17 is capable of searching for and acquiring content-related information about a content recorded on DVD (digital versatile disc) or like media and presenting the viewer with the acquired content-related information when the recorded content is reproduced from the recording media. As illustrated, the recording media reproducing terminal 71 has a recording media read section 82, a title information extraction section 83, a content-related information search and acquisition section 84, an output control section 85, and an operation section 86 implemented inside.

The recording media read section 82 reads recorded contents such as movies from recording media 81 and outputs the retrieved contents to the output control section 85. The recording media read section 82 further reads attribute information about a given content from the recording media and outputs the retrieved information to the title information extraction section 83. The recording media 81 hold information such as content titles as attribute information about the contents recorded thereon.

The title information extraction section 83 extracts the title of a given content from the attribute information supplied by the recording media read section 82. The extracted title is output to the content-related information search and acquisition section 84.

The content-related information search and acquisition section 84 searches for content-related information based on the content-related information list obtained from the content-related information providing site managing apparatus 4 and on the title fed from the title information extraction section 83, thereby acquiring from the managing apparatus 4 the content-related information about the content retrieved from the recording media 81 and targeted for processing. The content-related information search and acquisition section 84 thus obtains the content-related information whose list item describes the same title as that supplied from the title information extraction section 83.

The output control section 85 reproduces the content sent from the recording media read section 82, displaying the video of the content on the display device and outputting the audio through the speakers. Furthermore, the output control section 85 outputs the images or moving picture of an appropriate website on the display device and outputs the audio involved through the speakers as described above, on the basis of the content-related information acquired by and sent from the content-related information search and acquisition section 84.

The operation section 86 accepts the operations performed by the viewer, and outputs information denoting what the operations signify to the output control section 85.

As described, it can be arranged to output information based on content-related information upon reproduction of the corresponding content recorded on DVD or like recording media.

It is also possible to output information based on content-related information upon reproduction of a content provided over the Internet.

The series of steps or processes described above may be executed either by hardware or by software. For the software-based processing to take place, the programs constituting the software may be either incorporated beforehand in dedicated hardware of a computer for program execution or installed upon use from suitable program recording media into a general-purpose personal computer or like equipment capable of executing diverse functions based on the installed programs.

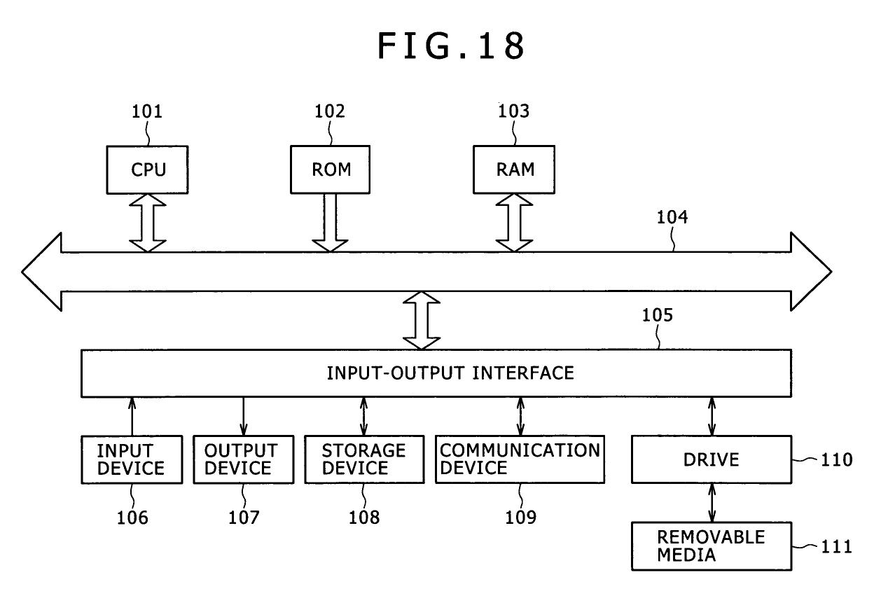

FIG. 18 is a block diagram showing a typical structure of a personal computer capable of executing a series of steps using programs. A CPU (central processing unit) 101 carries out diverse processes in accordance with the programs held in a ROM (read only memory) 102 or on a storage device 108. A RAM (random access memory) 103 accommodates the programs and data executed and operated on by the CPU 101 as needed. The CPU 101, ROM 102, and RAM 103 are interconnected by a bus 104.

An input/output interface 105 is connected via the bus 104 to the CPU 101. The input/output interface 105 is connected with an input device 106 and an output device 107. The input device 106 is typically made up of a keyboard, a mouse and a microphone. The output device 107 is illustratively constituted by a display device and speakers. The CPU 101 carries out various processes in response to commands that are input through the input device 106. The result of the processing is output from the CPU 101 to the output device 107.

The storage device 108 connected to the input/output interface 105 is illustratively a hard disk drive that stores the programs for execution by the CPU 101 as well as diverse data. A communication device 109 also connected to the input/output interface 105 communicates with external equipment over networks such as the Internet or a local area network.

A drive 110 connected to the input/output interface 105 is loaded with removable media 111 such as a magnetic disk, an optical disk, a magneto optical disk, or a semiconductor memory. In operation, the drive 110 drives the loaded medium and acquires the programs and/or data stored thereon. The acquired programs and data are transferred as needed to the storage device 108 for storage.

As shown in FIG. 18, the program recording media for accommodating computer-installable, computer-executable programs designed to perform the above-described processes are constituted either by the removable media 111 provided as package media such as magnetic disks (including flexible disks), optical disks (including CD-ROM (compact disc-read only memory) and DVD (digital versatile disc)), magneto optical disks, or a semiconductor memory; or by the ROM 102 and a hard disk drive making up the storage device 108 having the programs stored thereon temporarily or permanently. The programs may be recorded as needed to the recording media via the communication device 109 such as a router or a modem interfaced with wired or wireless communication media including local area networks, the Internet, and digital satellite broadcasting networks.

In this specification, the steps which describe the programs offered as mentioned above represent not only the processes that are to be carried out in the depicted sequence (i.e., on a time series basis) but also processes that may be performed parallelly or individually and not chronologically.

In this specification, the term “system” refers to an entire configuration made up of a plurality of component devices and apparatuses.

It should be understood by those skilled in the art that various modifications, combinations, sub-combinations and alterations may occur depending on design requirements and other factor in so far as they are within the scope of the appended claims or the equivalents thereof.

1. An information processing system comprising:
an information providing apparatus; and
a reproducing apparatus;
wherein said information providing apparatus is connected via a network to said reproducing apparatus configured to reproduce contents and to a creating apparatus configured to create related information about said contents,
said information providing apparatus including
an acquisition section configured to acquire said related information created by said creating apparatus,
a creation section configured to create a list of the acquired related information including content identification information associated with said related information, and
a transmission section configured to transmit said list to said reproducing apparatus and, as requested by said reproducing apparatus based on information included in said list, further transmit the related information about a given content to said reproducing apparatus, and
wherein said reproducing apparatus is connected to said information providing apparatus via said network,
said reproducing apparatus including
an acquisition section configured to acquire said list from said information providing apparatus and, based on said content identification information included in said list, further acquire from said information providing apparatus the related information about the content selected to be processed, and
an output section configured to output relevant information during reproduction of the selected content in accordance with information included in said related information acquired by said acquisition section.

2. An information providing apparatus connected via a network to a reproducing apparatus configured to reproduce contents and to a creating apparatus configured to create related information about said contents, said information providing apparatus comprising:
an acquisition section configured to acquire said related information created by said creating apparatus;
a creation section configured to create a list of the acquired related information including content identification information associated with said related information; and
a transmission section configured to transmit said list to said reproducing apparatus and, as requested by said reproducing apparatus based on information included in said list, further transmit the related information about a given content to said reproducing apparatus.

3. An information providing method for use with an information providing apparatus connected via a network to a reproducing apparatus configured to reproduce contents and to a creating apparatus configured to create related information about said contents, said information providing method comprising:
acquiring said related information created by said creating apparatus;
creating a list of the acquired related information including content identification information associated with said related information; and
transmitting said list to said reproducing apparatus and, as requested by said reproducing apparatus based on information included in said list, further transmitting the related information about a given content to said reproducing apparatus.

4. A program for causing a computer to execute an information providing process of an information providing apparatus connected via a network to a reproducing apparatus configured to reproduce contents and to a creating apparatus configured to create related information about said contents, said program comprising:
acquiring said related information created by said creating apparatus;
creating a list of the acquired related information including content identification information associated with said related information; and
transmitting said list to said reproducing apparatus and, as requested by said reproducing apparatus based on information included in said list, further transmitting the related information about a given content to said reproducing apparatus.

5. A reproducing apparatus connected via a network to an information providing apparatus which acquires related information about contents from a creating apparatus configured to create said related information and which for management purposes creates a list of the acquired related information including content identification information associated with said related information, said reproducing apparatus comprising:
an acquisition section configured to acquire said list from said information providing apparatus and, based on said content identification information included in said list, further acquire from said information providing apparatus the related information about the content selected to be processed; and
an output section configured to output relevant information during reproduction of the selected content in accordance with information included in said related information acquired by said acquisition section.

6. The reproducing apparatus according to claim 5, wherein, if information for setting timings to output said relevant information is included in said related information acquired by said acquisition section, then said output section outputs said relevant information during reproduction of the selected content in keeping with the output timings thus set.

7. The reproducing apparatus according to claim 5, wherein said output section displays a table of said related information acquired by said acquisition section and, based on information included in the related information selected by a user from said table, outputs said relevant information.

8. The reproducing apparatus according to claim 7, wherein, if said list further includes abstracts from said related information, then said output section displays said table of said related information acquired by said acquisition section together with the abstracts corresponding to individual items of said related information.

9. The reproducing apparatus according to claim 5, wherein said acquisition section acquires said list from said information providing apparatus periodically at predetermined intervals whenever acquiring said related information from said creating apparatus, said acquisition section further acquiring said list alternatively when notified of any update in said list of said related information about said contents.

10. The reproducing apparatus according to claim 5, wherein said acquisition section acquires from said information providing apparatus the related information about the content selected to be processed, in accordance with information including a URL indicating where the content-related information included in said list is located.

11. The reproducing apparatus according to claim 5, wherein, during reproduction of said selected content, said output section outputs the information designated by a user of said creating apparatus in accordance with information included in said related information acquired by said acquisition section.

12. The reproducing apparatus according to claim 5, wherein, if a keyword included in either a title or constituents of the content selected to be processed is found to have a match in any of the contents covered by said list, then said acquisition section acquires the related information from said information providing apparatus.

13. The reproducing apparatus according to claim 5, further comprising a recording control section configured to control recording of a desired content;
wherein said acquisition section acquires the related information about said desired content to be recorded from said information providing apparatus; and
wherein said output section outputs to said recording control section said related information about said desired content acquired by said acquisition section in conjunction with said desired content.

14. An information processing method for use with a reproducing apparatus connected via a network to an information providing apparatus which acquires related information about contents from a creating apparatus configured to create said related information and which for management purposes creates a list of the acquired related information including content identification information associated with said related information, said information processing method comprising:
acquiring said list from said information providing apparatus and, based on said content identification information included in said list, further acquiring from said information providing apparatus the related information about the content selected to be processed; and
outputting relevant information during reproduction of the selected content in accordance with information included in said related information acquired.

15. A program for causing a computer to execute information processing of a reproducing apparatus connected via a network to an information providing apparatus which acquires related information about contents from a creating apparatus configured to create said related information and which for management purposes creates a list of the acquired related information including content identification information associated with said related information, said program comprising:
acquiring said list from said information providing apparatus and, based on said content identification information included in said list, further acquiring from said information providing apparatus the related information about the content selected to be processed; and
outputting relevant information during reproduction of the selected content in accordance with information included in said related information acquired.
